(19) United States
(12) Patent Application Publication
(10) Pub. No.: US 2010/0207089 A1
(43) Pub. Date: Aug. 19, 2010

(54) SUPPORT MEMBER FOR SUPPORTING A RAIL

(75) Inventors: Ronald S. Shoaf, Advance, NC (US); Vernon A. Copeland, JR., Brunswick, GA (US); Michael T. Shields, Monticello, GA (US); James F. Blocker, Hagan, GA (US)

Correspondence Address: Georgia-Pacific LLC, 133 Peachtree Street NE - GA030-41, ATLANTA, GA, 30303, US

(73) Assignee: GEORGIA-PACIFIC WOOD PRODUCTS LLC, Atlanta, GA (US)

(21) Appl. No.: 12/706,008

(22) Filed: Feb. 16, 2010

Related U.S. Application Data
(60) Provisional application No. 61/152,877, filed on Feb. 16, 2009.

(51) Int. Cl. E04H 17/14; E04H 17/20; B27H 1/00; B65B 13/02

(52) U.S. Cl. 256/65.02; 52/831; 144/359; 53/399

(57) ABSTRACT

A support member, such as a fence post, and method for making the same are provided. In at least one specific embodiment, the support member includes an elongated body having at least one substantially flat side, and at least one longitudinal groove at least partially disposed within the substantially flat side.

### CROSS REFERENCE TO RELATED APPLICATION

This application claims priority to U.S. application Ser. No. 61/152,877, filed Feb. 16, 2009, which is herein incorporated by reference in its entirety.

### BACKGROUND OF THE INVENTION

1. Field of the Invention

Embodiments of the present invention generally relate to apparatus and methods for supporting a rail. More particularly, embodiments of the present invention relate to fence posts and methods of making and using the same.

2. Description of the Related Art

Fence posts are typically available in metal, concrete, plastic and wood, and are usually round or rectangular. Round wooden fence posts are often made from the upper branches of trees that are cut to the proper length and “peeled” to remove the bark. These round fence posts are often non-linear, of varying sizes, and tapered from one end to the other, due to the variations of the particular tree branch from which the post is made.

After being cut to a desired dimension, wooden fence posts are often dried, either by air or kiln drying, to reduce the moisture content. The drying process often causes surface checking or splitting, which produces an uneven surface and/or cracks during use.

There is a need, therefore, for improved wooden support members, such as fence posts, having a reduced amount of surface checking and methods for producing the same.

### SUMMARY OF THE INVENTION

A support member and method for making the same are provided. In at least one specific embodiment, the support member includes an elongated body having at least one substantially flat side, and at least one longitudinal groove at least partially disposed within the substantially flat side.

In at least one specific embodiment, the method includes forming a substantially flat side along a length of an elongated body; and forming a longitudinal groove within the substantially flat side, wherein the groove at least partially extends from a first end to a second end of the elongated body.

A fence system is also provided. In at least one specific embodiment, the fence system includes two or more support members disposed in and extending from a surface, the support members comprising: an elongated body having at least one substantially flat side, and at least one longitudinal groove at least partially disposed within the substantially flat side. One or more rails can be disposed between the two or more elongated members to provide a rail or fence.

A method of packaging a plurality of support members is also provided. In at least one specific embodiment, the method includes locating a first layer of two or more support members onto a surface, wherein the support members are parallel, and locating one or more spacers onto the first layer. A second layer of two or more support members can be located onto the one or more spacers, wherein the support members are parallel to the first layer of support members, each support member comprising: an elongated body having at least one substantially flat side; and at least one longitudinal groove at least partially disposed within the substantially flat side. One or more bands can be secured about the first layer and the second layer to secure the first layer and the second layer together to provide a bundled unit of support members.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an isometric view of an illustrative support member, according to one or more embodiments described.

FIG. 2 depicts a cross-sectional view of the support member depicted in FIG. 1 along line 2-2.

FIG. 3 depicts an isometric view of a plurality of stacked support members, according to one or more embodiments described.

FIG. 4 depicts an illustrative fence system, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

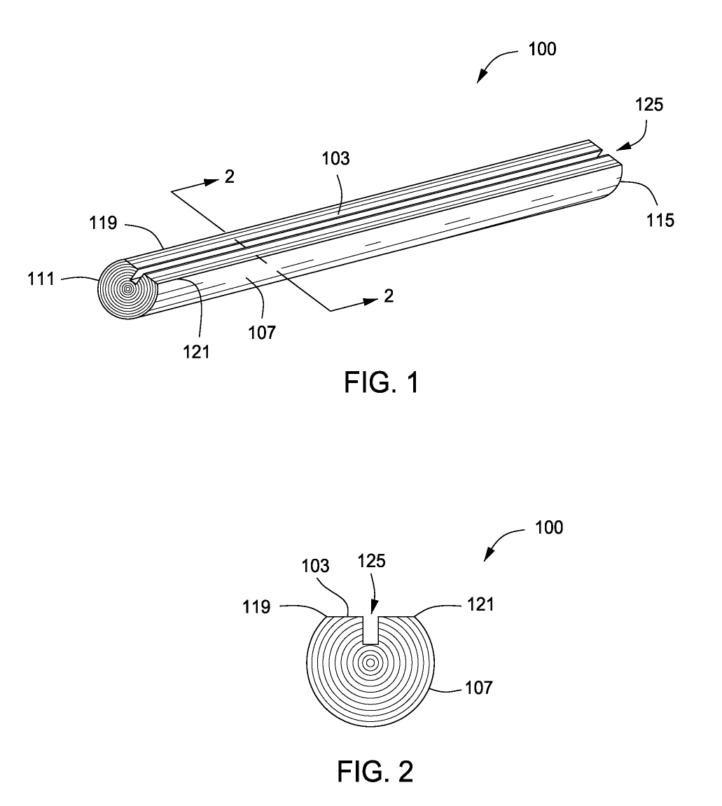

FIG. 1 depicts an isometric view of an illustrative support member 100, according to one or more embodiments. The support member 100 can include an elongated body having at least a first side or portion 103 located about a longitudinal axis thereof that is substantially flat or substantially planar, and at least a second portion or side 107 located about a longitudinal axis thereof that is not substantially flat or substantially planar. The support member 100 can further include one or more notches or recessed grooves 125 (only one is shown) formed therein. The one or more notches or recessed grooves 125 can run the entire length of the support member 100 or one or more portions thereof. The groove(s) 125 can be continuous or non-continuous, and can be formed in either the flat side 103 or the curved side 107, or a combination of both sides 103, 107. Preferably, the groove 125 is at least partially disposed on the flat side 103, as depicted in FIG. 1.

FIG. 2 depicts a cross-sectional view of the support member depicted in FIG. 1 along line 2-2. Referring to FIGS. 1 and 2, the substantially flat side 103 can be formed about a portion of the outer perimeter of the support member 100 or about the entire length thereof. The flat side 103 can have end point or edges 119, 121. The second side (“curved side” or “non-flat side”) 107 of the support member 100 can account for the remainder of the outer perimeter of the support member 100. For example, the curved side 107 can extend from the first edge 119 to the second edge 121 of the flat side 103, as shown in FIG. 2. Although the curved side 107 is depicted as a smooth curve or circular, the curved side 107 can be or include any type of curved profile, including an elliptical, oval, or the like.

As mentioned above, each groove 125 can be disposed along the entire length of the flat side 103 extending from the first end 111 thereof to the second end 115 thereof. Each groove 125 can also be formed in one or more locations between the ends 111, 115. Each groove 125 can be continuous or non-continuous about the entire length of the support member 100 or any portion thereof. Preferably, at least one groove 125 can be longitudinally disposed, entirely or at least partially, along a central portion or center line of the flat side 103 between its first edge 119 and its second edge 121. However, any number of grooves 125 can be formed in any pattern on or about the centerline of the flat side 103, and any number of grooves 125 having any combination or variation of lengths can be formed about the support member 100. In at least one specific embodiment, two or more longitudinal grooves 125 can be at least partially disposed along a length of the flat side 103, either in parallel or offset from one another in any relation to the centerline.

The width of each groove 125 can range from a low of about 0.5 mm (0.02 in), about 1 mm (0.04 in), about 2 mm (0.08 in), or about 3 mm (0.12 in) to a high of about 5 mm (0.2 in), about 6 mm (0.24 in), about 7 mm (0.27 in.), or about 10 mm (0.4 in). For example, the groove 125 can have a width of about 2.5 mm (0.1 in), about 3.5 mm (0.14 in), about 4 mm (0.16 in), about 4.5 mm (0.18 in), or about 5.5 mm (0.22 in). In one or more embodiments, the groove 125 width can range from about 0.5 mm (0.02 in) to about 10 mm (0.4 in); or about 1 mm (0.04 in) to about 5.5 mm (0.22 in); or about 2 mm (0.08 in) to about 4 mm (0.16 in).

The depth of the groove 125 can range from a low of about 6 mm (0.24 in), about 12 mm (0.47 in), or about 15 mm (0.59 in) to a high of about 50 mm (2 in), about 60 mm (2.4 in), or about 70 mm (2.6 in). For example, the groove 125 can have a depth of about 17 mm (0.67 in), about 22.5 mm (0.88 in), about 28 mm (1.1 in), about 33 mm (1.3 in), or about 44 mm (1.7 in). In one or more embodiments, the groove 125 depth can range from about 0.5 mm (0.02 in) to about 44 mm (1.7 in); or about 1 mm (0.04 in) to about 20 mm (0.8 in); or about 2 mm (0.08 in) to about 10 mm (0.4 in).

In one or more embodiments, each groove 125 can have an aspect ratio (depth:width) of about 20:1; or about 15:1; or about 10:1; or about 5:1; or about 4:1; or about 3:1; or about 2:1; or about 1:1. The aspect ratio of each groove 125 can range from a low of about 1:1; 5:1 or 10:1 to a high of about 11:1; 15:1 or 20:1. The aspect ratio of each groove 125 can also range from a low of about 1:1; 3:1 or 5:1 to a high of about 7:1; 10:1 or 15:1.

In one or more embodiments, each groove 125 can have a squared or rectangular cross-sectional profile, as depicted in FIG. 2. However, each groove 125 can have any cross-sectional shape or cross-sectional profile, including a rounded “U” shape or straight “V” shape. When two or more grooves 125 are used, the cross-sectional profile of each groove 125 can be the same or different. Further, any portion of any given groove 125 can have the same or a different cross-sectional profile. For example, a particular groove 125 can have at least a first portion that is squared or rectangular and at least a second portion that is “U” or “V” shaped. The cross-sectional type or shape of the groove 125 can depend on the moisture content of the support member 100 and/or the environment in which the support member 100 is intended to be used.

The support member 100 can have any suitable diameter or cross-sectional width. When the support member 100 begins as a cylindrical body before forming the flat side 103, the cylindrical support member 100 can have a diameter ranging from a low of about 6 cm (2.4 in), about 7.5 cm (2.9 in), about 8.5 cm (3.3 in), or about 10 cm (3.9 in) to a high of about 12.5 cm (4.9 in), about 15 cm (6 in), about 20 cm (7.9 in), or about 30 cm (11.8 in) or more. More preferably, the support member 100 can have a diameter of about 7.6 cm (3 in), about 10 cm (4 in), about 15 cm (6 in), or about 20 cm (8 in). The cross-section width or distance along the flat side 103 between edges 119 and 121 (“the width of the cut side”) can range from a low of about 3 cm (1.7 in), about 6 cm (2.4 in), about 7.5 cm (2.9 in), about 8.5 cm (3.3 in), or about 10 cm (3.9 in) to a high of about 12.5 cm (4.9 in), about 15 cm (6 in), about 20 cm (7.9 in), or about 30 cm (11.8 in) or more. More preferably, the support member 100 can have a diameter of about 7.6 cm (3 in), about 10 cm (4 in), about 15 cm (6 in), or about 20 cm (8 in).

The length of the support member 100 can vary. For example, the length of the support member 100 can range from a low of about 0.3 m (1 ft), about 0.6 m (2 ft), about 1.2 m (4 ft), about 1.8 m (6 ft), or about 2.1 m (7 ft) to a high of about 2.7 m (9 ft), about 3 m (10 ft), or about 3.8 m (12.5 ft). In one or more embodiments, the length of the support member 100 can be about 2 m (6.5 ft), about 2.4 m (8 ft), about 3 m (10 ft), or about 3.6 m (12 ft).

The support member 100 can be made from any material suitable for supporting a rail. Preferably, the support member 100 is made from or at least partially contains wood. Suitable woods include both hardwoods and softwoods. Illustrative types of wood can include, but are not limited to, Alder, Ash, Aspen, Basswood, Beech, Birch, Cedar, Cherry, Cottonwood, Cypress, Elm, Fir, Gum, Hackberry, Hickory, Maple, Oak, Pecan, Pine, Poplar, Redwood, Sassafras, Spruce, Sycamore, Walnut, and Willow.

The support member 100 can be formed using any suitable system, device, or combination of systems and/or devices. For example, in the event the support member 100 is made of wood, a rough piece of wood can be rounded using a lathe to provide an elongated body having the curved side 107, which can completely extend around the entire circumference thereof. The elongated body can then be cut using a saw, for example, to provide the flat side 103 having the substantially flat or substantially planar surface. One or more grooves 125 can then be cut or formed along at least a portion of the flat side 103 using a saw, for example.

The support member 100 can be dried. Illustrative drying methods can include, but are not limited to, air drying, kiln drying, or a combination thereof. The support member 100 can be dried to provide a support member 100 having less than about 30%, less than about 25%, less than about 20%, less than about 15%, or less than about 10% moisture content. Preferably, the moisture content is about 20% or less, about 19% or less, about 17% or less, or about 14% or less. Drying the support member 100 can provide several benefits including increased strength, reduced weight, and/or a reduction or elimination of insects and/or insect eggs. Not wishing to be bound by theory, the groove 125 has been found to surprisingly reduce the amount of surface checking or splitting during drying by relieving or reducing stress along the flat side 103. As a result, the support member 100 maintains it structural integrity during transport and use.

After drying, the support member 100 can be treated to resist rot, insects, fungus, and other environmental factors. One or more waterborne preservatives, creosote preservatives, oil-borne preservatives, or any other preservatives known to those in the art of wood preservation can be used. Illustrative waterborne preservatives can include, but are not limited to, Ammoniacal Copper Arsenate (“ACA”), Ammoniacal Copper Zinc Arsenate (“ACZA”), Chromated Copper Arsenate (“CCA”), Acid Copper Chromate (“ACC”), Ammoniacal Copper Quat type B (“ACQ-B”), Amine Copper Quat type D (“ACQ-D”), Ammonical Copper Citrate (“CC”), Micronized Copper Quat (“MCQ”), Copper Azole (“CA”), and Borate Oxide (“SBX”). Illustrative oil-borne preservatives can include, but are not limited to, chlorpyrifos/IBPC, copper naphthenate, copper-8-quinolinolate, and pentachlorphenol. A properly treated support member 100 can contain about 1.6 kg/m³ (0.1 lb/ft³), about 4 kg/m³ (0.25 lb/ft³), about 6.4 kg/m³ (0.4 lb/ft³), about 9.6 kg/m³ (0.6 lb/ft³), or about 40 kg/m³ (2.5 lb/ft³) of preservative.

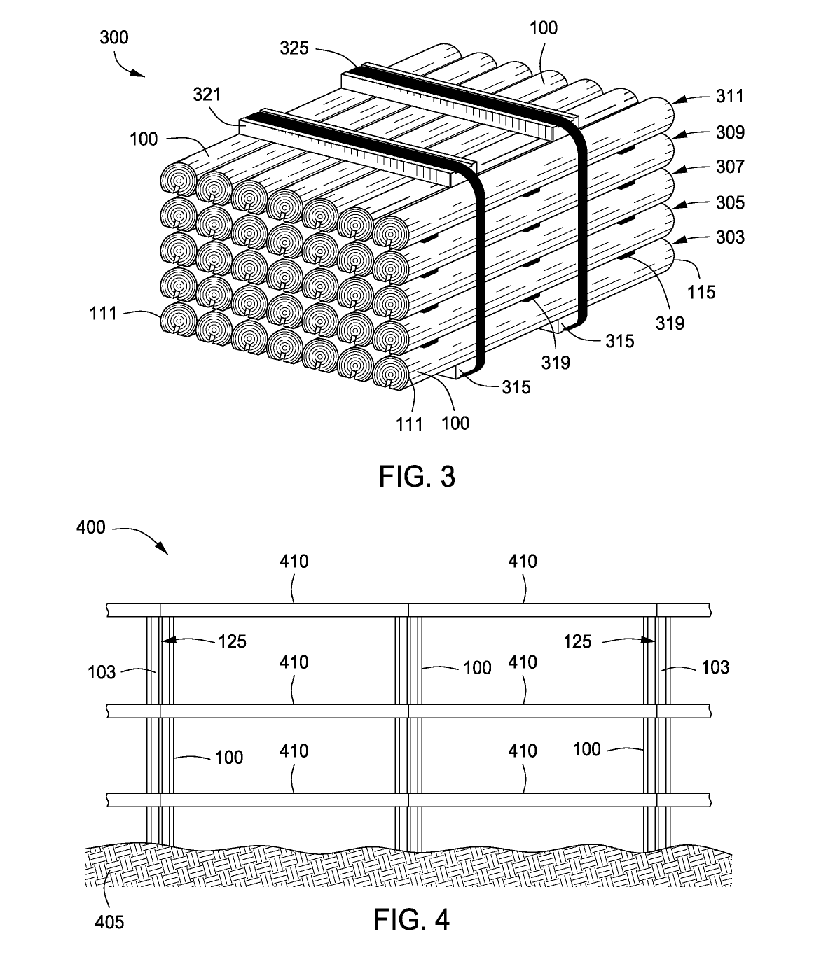

FIG. 3 depicts an isometric view of a plurality of stacked support members 100, according to one or more embodiments. A plurality of support members 100 can be positioned or arranged into one or more stacks or layers (five are shown 303, 305, 307, 309, 311), which can be secured together to provide a bundled unit 300. The bundled unit 300 can include any number of support members 100 in any given layer 303, 305, 307, 309, 311. For example, each layer 303, 305, 307, 309, 311 in the bundled unit 300 can include four or more, six or more, eight or more, ten or more, twelve or more, or fourteen or more support members 100. The bundled unit 300 can also include any number of layers although five are shown 303, 305, 307, 309, 311. For example, the bundled unit 300 can include one or more, two or more, three or more, four or more, five or more, six or more, seven or more, eight or more, nine or more, or ten or more layers.

In each layer 303, 305, 307, 309, 311, the substantially flat side 103 of each support member 100 can be laid faced down to prevent or reduce the support members 100 from rolling during storage or transport. In at least one specific embodiment, one or more lower or base supports (two are shown 315) can be used to prevent or maintain the lower layer 303 out of contact with the ground, storage shelf, or other surface. One or more spacer boards (three are shown 319) can be disposed between rows to add further support and spacing between each layer 303, 305, 307, 309, 311. One or more upper or top supports 321 (two are shown) can be placed on top of the upper layer 311, which can protect the upper layer during stacking of multiple bundled units 300.

A banding, strap, or other tie 325 can be disposed about the stacked support members 100 and tightened to retain or prevent the bundled unit 300 from tipping/un-layering/rolling during storage and/or transportation. The banding 325 can be disposed about the base supports 315 and/or the upper supports 321. The base support 315 and the upper support 321 can provide a barrier between the banding 325 and the stacked support members 100, which can reduce or prevent damage and/or movement of the support members 100 in the stacked layers 303, 305, 307, 309, 311 when the banding 325 is applied. The bundled unit 300 can be easily lifted and/or moved using a forklift (not shown), for example, and can also be easily transported via rail, truck, ship, or the like.

FIG. 4 depicts an illustrative fence system 400, according to one or more embodiments. As shown, a plurality of the support members 100 can be aligned and positioned in the ground or other surface 405 to provide a support structure for a fence, railing, or the like. The support members 100 can be further secured within the surface 405 using cement, concrete, gravel, or any other suitable binder. Illustrative surfaces 405 can include, but are not limited to, the ground, a cement slab, or the like.

To construct the fence system 400, the substantially flat side 103 of each support member 100 can be aligned with one another. The substantially flat or planar surface of the flat side 103 can provide a flat or even surface suitable for securing one or more rails 410 thereto. As illustrated, three rails 410 can be vertically spaced and positioned between two adjacent support members 100 and secured to the flat side 103 of each support member 100 to provide the fence system 400. Illustrative fasteners that can be used to secure the one or more rails 410 to the support members 100 can include, but are not limited to, nails, screws, bolts, bolts and nuts, adhesives, and the like.

Illustrative rails 410 can include, but are not limited to, rounded poles or logs, rectangular slats or rails of wood, or the like. Although not shown, other types of rails 410 can include, but are not limited to, ropes, cables, wires, barbed wires, chains, straps, cords, rods, bars, tubulars, plastic or other flexible or non-flexible meshes or screens, metal cyclone fencing, and the like. In one or more embodiments, one or more slats or pickets can be vertically secured to the one or more rails 410 disposed between two or more support members 100. The fence system 400 can have any suitable height and/or length. The upper rail 410 and/or the top of the support member 100 can be about 0.9 m (3 ft), about 1.2 m (4 ft), about 1.5 m (5 ft), about 1.8 m (6 ft), about 2.1 m (7 ft), about 2.4 m (8 ft), about 2.7 m (9 ft), or about 3 m (10 ft) or more above the surface 405.

In another embodiment, the present invention relates to:

1. A support member, comprising: an elongated body having at least one substantially flat side; and at least one longitudinal groove at least partially disposed within the substantially flat side.

2. The support member according to paragraph 1, wherein the elongated body is made of wood.

3. The support member according to paragraph 1 or 2, wherein the wood is pressure treated.

4. The support member according to any of paragraphs 1 to 3, wherein the groove has a width ranging from about 3 mm (0.12 in) to about 5 mm (0.2 in).

5. The support member according to any of paragraphs 1 to 4, wherein the groove has a depth ranging from about 1.3 cm (0.51 in) to about 4.4 cm (1.7 in).

6. The support member according to any of paragraphs 1 to 5, wherein the elongated body has a length ranging from about 1.5 m (4.9 ft) to about 3 m (10 ft).

7. The support member according to any of paragraphs 1 to 6, wherein the elongated body has a cross-sectional length ranging from abut 7.5 cm (2.9 in) to about 31 cm (12.2 in).

8. The support member according to any of paragraphs 1 to 7, wherein the longitudinal groove is at least partially disposed between a first edge and a second edge of the substantially flat side.

9. A method for making a support member, comprising: forming a substantially flat side along a length of an elongated body; and forming a longitudinal groove within the substantially flat side, wherein the groove at least partially extends from a first end to a second end of the elongated body.

10. The method according to claim 9, further comprising forming the elongated member by machining a rough log stock on a lathe to provide the elongated member having the curved cross-section.

11. The method according to paragraphs 9 or 10, wherein the elongated body is made of wood, the method further comprising drying the elongated body to provide an elongated body having a moisture content less than about 25%.

12. The method according to paragraph 11, further comprising pressure treating the elongated body.

13. The method according to any of paragraphs 9 to 12, wherein the groove has a width ranging from about 3 mm (0.12 in) to about 5 mm (0.2 in) and a depth ranging from about 1.3 cm (0.5 in) to about 4.4 cm (1.7 in).

14. A fence system, comprising: two or more support members disposed in and extending from a surface, the support members comprising: an elongated body having at least one substantially flat side; and at least one longitudinal groove at least partially disposed within the substantially flat side; and one or more rails disposed between the two or more elongated members to provide a rail or fence.

15. The fence system according to paragraph 14, wherein the substantially flat sides of the two or more support members are aligned.

16. The system according to paragraphs 14 or 15, wherein the two or more elongated bodies are made from pressure treated wood.

17. A method of packaging a plurality of support members, comprising:

locating a first layer of two or more support members onto a surface, wherein the support members are parallel;

locating one or more spacers onto the first layer;

locating a second layer of two or more support members onto the one or more spacers, wherein the support members are parallel to the first layer of support members, each support member comprising:
an elongated body having at least one substantially flat side; and
at least one longitudinal groove at least partially disposed within the substantially flat side; and

securing one or more bands about the first layer and the second layer to secure the first layer and the second layer together to provide a bundled unit of support members.

18. The method according to paragraph 17, further comprising transporting the bundled unit of support members from a first location to a second location.

19. The method according to paragraphs 17 or 18, wherein the surface comprises one or more base supports and wherein the substantially flat side of the support members faces toward the surface.

20. The method according to any of paragraphs 17 to 19, wherein the support members are made from pressure treated wood and wherein the bundled unit comprises three or more layers of support members and wherein each layer comprises at least six support members.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A support member, comprising:
an elongated body having at least one substantially flat side; and
at least one longitudinal groove at least partially disposed within the substantially flat side.

2. The support member of claim 1, wherein the elongated body is made of wood.

3. The support member of claim 2, wherein the wood is pressure treated.

4. The support member of claim 1, wherein the groove has a width ranging from about 3 mm (0.12 in) to about 5 mm (0.2 in).

5. The support member of claim 1, wherein the groove has a depth ranging from about 1.3 cm (0.51 in) to about 4.4 cm (1.7 in).

6. The support member of claim 1, wherein the elongated body has a length ranging from about 1.5 m (4.9 ft) to about 3 m (10 ft).

7. The support member of claim 1, wherein the flat side has a cross-sectional width of from about 7.5 cm (2.9 in) to about 31 cm (12.2 in).

8. The support member of claim 1, wherein the longitudinal groove is at least partially disposed between a first edge and a second edge of the substantially flat side.

9. A method for making a support member, comprising:
forming a substantially flat side along a length of an elongated body; and
forming a longitudinal groove within the substantially flat side, wherein the groove at least partially extends from a first end to a second end of the elongated body.

10. The method of claim 9, further comprising forming the elongated member by machining a rough log stock on a lathe to provide the elongated member having a curved cross-section.

11. The method of claim 9, wherein the elongated body is made of wood, and further comprising drying the elongated body to provide an elongated body having a moisture content less than about 25%.

12. The method of claim 11, further comprising pressure treating the elongated body.

13. The method of claim 9, wherein the groove has a width ranging from about 3 mm (0.12 in) to about 5 mm (0.2 in) and a depth ranging from about 1.3 cm (0.5 in) to about 4.4 cm (1.7 in).

14. A fence system, comprising:
two or more support members disposed in and extending from a surface, the support members comprising:
an elongated body having at least one substantially flat side; and
at least one longitudinal groove at least partially disposed within the substantially flat side; and
one or more rails disposed between the two or more elongated members to provide a rail or fence.

15. The fence system of claim 14, wherein the substantially flat sides of the two or more support members are aligned.

16. The system of claim 14, wherein the two or more elongated bodies are made from pressure treated wood.

17. A method of packaging a plurality of support members, comprising:
locating a first layer of two or more support members onto a surface, wherein the support members are parallel;
locating one or more spacers onto the first layer;
locating a second layer of two or more support members onto the one or more spacers, wherein the support members are parallel to the first layer of support members, each support member comprising:
an elongated body having at least one substantially flat side; and
at least one longitudinal groove at least partially disposed within the substantially flat side; and
securing one or more bands about the first layer and the second layer to secure the first layer and the second layer together to provide a bundled unit of support members.

18. The method of claim 17, further comprising transporting the bundled unit of support members from a first location to a second location.

19. The method of claim 17, wherein the surface comprises one or more base supports and wherein the substantially flat side of the support members faces toward the surface.

20. The method of claim 17, wherein the support members are made from pressure treated wood and wherein the bundled unit comprises three or more layers of support members and wherein each layer comprises at least six support members.
